(19) United States
(12) Patent Application Publication
(10) Pub. No.: US 2009/0245890 A1
(43) Pub. Date: Oct. 1, 2009

(54) IMAGE FORMING APPARATUS AND DEVELOPER THEREOF

(75) Inventors: Seung Chan Park, Hwaseong-si (KR); Joon Hee Kim, Yongin-si (KR); Myoung Su Baek, Suwon-si (KR); Ho jin Jang, Incheon (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/208,475

(22) Filed: Sep. 11, 2008

(30) Foreign Application Priority Data
Mar. 31, 2008 (KR) 2008-29607

(51) Int. Cl. G03G 15/08

(52) U.S. Cl. 399/284

(57) ABSTRACT

An image forming apparatus and a developer thereof includes a developer frame to store a developing agent, a developing device rotatably mounted to the developer frame, a support member mounted to the developer frame, and a regulating member having a first end fixed to the support member, and a second end opposite to the first end, the second end installed in a trail-type manner. The support member includes a plurality of bending portions bent to reinforce a strength of the support member. A trail-type regulating device improved to maintain a sufficient strength and a sufficient elasticity is also disclosed. The regulating device allows the developing agent layer attached to the developing device can be uniform.

### CROSS-REFERENCE TO RELATED APPLICATIONS

This application claims priority under 35 U.S.C. §119(a) from Korean Patent Application No. 10-2008-29607, filed on Mar. 31, 2008 in the Korean Intellectual Property Office, the disclosures of which are incorporated herein in its entirety by reference.

### BACKGROUND OF THE INVENTION

1. Field of the Invention

The present general inventive concept relates to an image forming apparatus and a developer thereof, and, more particularly, to an image forming apparatus equipped with a developer including a regulator to regulate a developing agent attached to a developing device. The present general inventive concept also relates to the developer of the image forming apparatus.

2. Description of the Related Art

A conventional image forming apparatus forms an image on a printing medium in accordance with an input signal. Various image forming apparatuses having various functions are known. Examples of such image forming apparatuses include a printer, a copy machine, a facsimile machine, and a complex machine having the functions of the above-mentioned appliances.

An electro-photographic image forming apparatus, which is an example of a type of image forming apparatus, includes a photosensitive body, a light scanning unit, and a developing unit. The light scanning unit uses a light to scan the photosensitive body, which has been charged with a predetermined voltage, to form an electrostatic latent image thereupon. The developing unit supplies a developing agent to the photosensitive body formed with the electrostatic latent image, to form a visible image thereupon.

A conventional developing unit includes a developer to supply a developing agent stored in the developer, and a regulating blade to regulate the thickness of a developing agent layer attached to the developer.

The regulating blade may be classified into a counter type or a trail type in accordance with an installation type of the regulating blade. In the case of the counter type regulating blade, the regulator blade is arranged such that a free end of the regulator blade, which is in contact with the developer, is directed in a direction opposite to a rotation direction of the developer. In contrast, in the case of the trail type regulating blade, the regulator blade is arranged such that the free end contacting the developer is directed in the same direction as the rotation direction of the developer.

Although the counter type regulating blade provides advantages in that it is possible to uniformly form a developing agent layer, and to provide an excellent sealing performance for the developing unit, there is a disadvantage in reducing the size of the developing unit, due to the structural form of the counter type regulating blade. On the other hand, the trail type regulating blade is advantageous in reducing the size of the developing unit. However, the trail type regulating blade has disadvantages in that, if the regulating blade cannot maintain a desired strength and a desired elasticity, the regulating blade's regulation of the developing agent layer and sealing of the developing unit are rather inferior to that of the counter type regulating blade.

In the recent development of image forming apparatuses, efforts have been concentrated on miniaturization as an important development point. In order to positively utilize the trail type regulating blade, which is considerably advantageous in terms of miniaturization, it is necessary to appropriately compensate for the disadvantages incurred in the trail type regulating blade.

### SUMMARY OF THE INVENTION

The present general inventive concept provides a developer including a trail type regulator improved to maintain a sufficient strength and a sufficient elasticity, and an image forming apparatus including the developer.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a developer including a developer frame to store a developing agent, a developing device rotatably mounted to the developer frame, a support member mounted to the developer frame, and a regulating member having a first end fixed to the support member, and a second end opposite to the first end which is provided in a trail-type position, wherein the support member includes a plurality of bending portions bent to reinforce a strength of the support member.

The plurality of bending portions may include bending portions bent in different directions.

The plurality of bending portions may include a first bending portion bent in a first direction, to cause a portion of the support member to be directed to an inside of the developer frame.

The plurality of bending portions may include a second bending portion bent in a second direction, to cause a portion of the support member to be directed to an outside of the developer frame.

The support member may further include a frame coupling portion extending from the first bending portion, the frame coupling portion being coupled to the developer frame.

The developer frame may include a coupling groove to receive the frame coupling portion.

The support member may further include an inclined portion extending inclinedly from the first bending portion to the second bending portion, and an extension extending from the second bending portion toward the regulating member.

The developer frame may further include an inclined frame portion corresponding to the inclined portion of the support member.

The extension may be in contact with a developing agent storing space defined in the developer frame.

The extension may be formed with an indent to obtain a reinforcement in strength.

The developer may further include a first sealing member interposed between the support member and the developer frame near the first bending portion.

The developer frame may include supports to support opposite lateral ends of the support member. A second sealing member may be arranged between the supports of the developer frame the support member.

The support member may further include at least one engagement protrusion laterally protruded from one side of the support member. The developer frame may include at least one engagement groove engagable with the engagement protrusion.

The support member may further include a fastening hole to fasten the support member to the developer frame, and a guide slot to guide the support member to a fastening position.

The foregoing and/or other aspects and utilities of the present general inventive concept may also be achieved by providing an image forming apparatus including an image carrier, and a developer comprising a developer frame defined with a developer storing space in an interior of the developer frame, a developing device to feed a developing agent to the image carrier, a regulating member to regulate a thickness of a developing agent layer attached to the developing device, and a support member to support the regulating member and including a frame coupling portion fitted in the developer frame, an inclined portion bent from the frame coupling portion in a first direction, and extended along the developer frame, and an extension bent from the inclined portion in a second direction, and extended toward the regulating member, to cover a top of the developing agent storing space.

The developer may further include a sealing member interposed between the developer frame and the inclined portion.

The developer frame may include supports to support opposite lateral ends of the support member. A sealing member may be arranged between the supports of the developer frame the support member.

The support member may be primarily coupled to a side surface of the developer frame at one side of the support member, through groove and protrusion structures.

The support member, which has been primarily coupled to the developer frame at one side of the support member, may be fastened to the developer frame at the other side of the support member.

The foregoing and/or other aspects and utilities of the present general inventive concept may also be achieved by providing an image forming apparatus including a developer frame to store a developing agent, a developing device rotatably mounted to the developer frame, a support member mounted to the developer frame, the support member including at least one bending portion to reinforce a strength of the support member, and a regulating member having a first end fixed to the support member, and a second end opposite to the first end, and contacting the developing device while being directed in a same direction as the rotation direction of the developing device, wherein the regulating member includes at least one bending portion to reinforce an elasticity of the regulating member.

The support member may include a plurality of bending portions bent in different directions.

The plurality of bending portions may include a first bending portion bent in a first direction, to cause a portion of the support member to be directed to an inside of the developer frame.

The plurality of bending portions may include a second bending portion bent in a second direction, to cause a portion of the support member to be directed to an outside of the developer frame.

The at least one bending portion of the regulating member may include a first bending portion contacting the developing device.

The at least one bending portion of the regulating member may further include a second bending portion provided between the first bending portion of the regulating member and the support member.

The foregoing and/or other aspects and utilities of the present general inventive concept may also be achieved by providing a regulating device usable in a developer including a developer frame defined with a developer storing space in an interior of the developer frame, a developing device to feed a developing agent to form images, a regulating member to regulate a thickness of a developing agent layer attached to the developing device, and a support member to support the regulating member, the regulating device including a support member mounted to the developer frame, the support member including at least one bending portion to reinforce a strength of the support member, and a regulating member having a first end fixed to the support member, and a second end arranged opposite to the first end, and installed in a trail-type manner, the regulating member including at least one bending portion to reinforce an elasticity of the regulating member.

The foregoing and/or other aspects and utilities of the present general inventive concept may also be achieved by providing a developer, including a developer frame to store a developing agent and including a developing device rotatably mounted to the developer frame, and a regulating device to cover an opening of the developer frame to prevent the developing agent from leaking therefrom, and to regulate an amount of developer on a surface of the developing device, the regulating device including a plurality of bending portions bent to reinforce a strength thereof.

The regulating device may further include a support member comprising a frame coupling portion to couple the support member to the developer frame; and a regulating member coupled to the support member and to contact the surface of the developing device in a trailing type manner.

The developer frame may include a coupling groove, and the support member may further include a first bending portion expending to the frame coupling portion to allow the frame coupling portion to slidably insert into the coupling groove.

The support member may further include an inclined portion to couple to a corresponding inclined portion of the developer frame, a second bending portion coupled to the inclined portion such that the second bending portion is bent in a direction opposite to a direction which the first bending portion is bent, and a substantially horizontal extension to couple the second bending portion to the regulating member.

The support member may further include an indent portion formed along the substantially horizontal extension to protrude toward an inside portion of the developer frame.

The regulating member is coupled to a surface of the support member facing an inside portion of the developer frame.

The regulating member may include a first bending portion to allow a surface of the regulating member facing an inside portion of the developer frame to contact the developing device, and a second bending portion to bend the regulating member to form a free end which is perpendicular to a rotating direction of the developing device.

The developer may further include a plurality of supports disposed on the developer frame to support the support member on longitudinal and lateral ends thereof.

The developer may further include a sealing member disposed on the plurality of supports to prevent the developing agent from leaking between the developer frame and the support member.

The developer frame may further include a plurality of engagement grooves, and the support member may further include a plurality of engagement protrusions located on side portions thereof to slidably fit into the engagement grooves of the developer frame to couple the support member thereto.

### BRIEF DESCRIPTION OF THE DRAWINGS

These and/or other aspects and utilities of the present general inventive concept will become apparent and more readily appreciated from the following description of the embodiments, taken in conjunction with the accompanying drawings in which:

FIG. 1 is a view illustrating a configuration of an image forming apparatus according to an exemplary embodiment of the present general inventive concept;

FIG. 2 is a perspective view illustrating a developer illustrated in FIG. 1;

FIG. 3 is a sectional view illustrating the developer illustrated in FIG. 2;

FIG. 4 is a perspective view illustrating a regulating device illustrated in FIG. 3;

FIG. 5 is a cross-sectional view taken along a line I-I of FIG. 4, illustrating the regulating device; and

FIGS. 6 and 7 are exploded perspective views of the developer illustrated in FIG. 2.

### DETAILED DESCRIPTION OF THE PREFERRED EMBODIMENTS

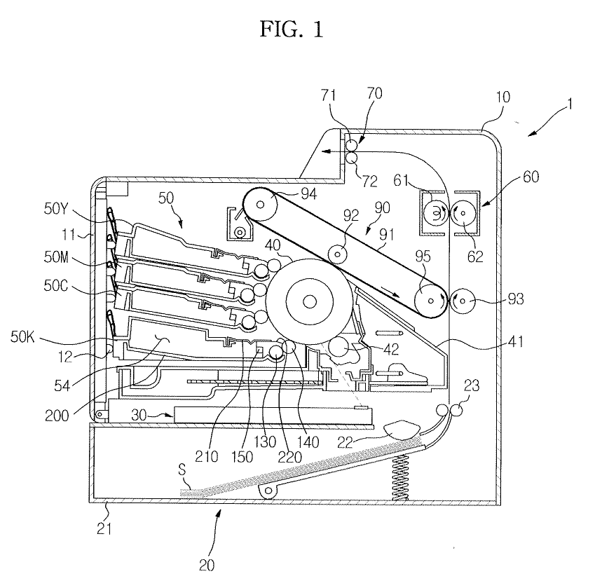

Reference will now be made in detail to the embodiments of the present general inventive concept, examples of which are illustrated in the accompanying drawings. The embodiments are described below to explain the present general inventive concept by referring to the figures. FIG. 1 is a view illustrating a configuration of an image forming apparatus according to an exemplary embodiment of the present general inventive concept.

As illustrated in FIG. 1, the image forming apparatus 1 includes a body 10, a printing medium supply unit 20, a light scanning unit 30, a photosensitive body 40, a developing unit 50, a transfer unit 90, a fusing unit 60, and a printing medium discharge unit 70.

The body 10 defines an outer appearance of the image forming apparatus 1, and supports various elements arranged in the body 10. A body cover 11 is pivotally mounted to the body 10 at one side of the body 10. The body cover 11 partially opens or closes the body 10.

The printing medium supply unit 20 includes a cassette 21 to store printing media S, a pick-up roller 22 to pick up the printing media S stored in the cassette 21 one sheet by one sheet, and a feeding roller 23 to feed the picked-up printing media S one at a time toward the transfer unit 90.

The light scanning unit 30 scans the photosensitive body 40 with light corresponding to predetermined image information, to form an electrostatic latent image on a surface of the photosensitive body 40.

The photosensitive body 40 is an image carrier to carry an electrostatic latent image formed by the light scanning unit 30 and a visible image formed by the developing unit 50. The photosensitive body 40 is rotatably mounted to a photosensitive body housing 41 detachably mounted to the body 10. A charging roller 42 is arranged in the photosensitive body housing 41. The charging roller 42 charges the photosensitive body 40 with a predetermined voltage before the photosensitive body 40 is scanned by light from the light scanning unit 30.

The developing unit 50 supplies a developing agent to the photosensitive body 40 formed with the electrostatic latent image, to form a visible image thereupon. The developing unit 50 includes four developers 50Y, 50M, 50C, and 50K respectively containing developing agents of different colors, for example, yellow (Y), magenta (M), cyan (C), and black (K).

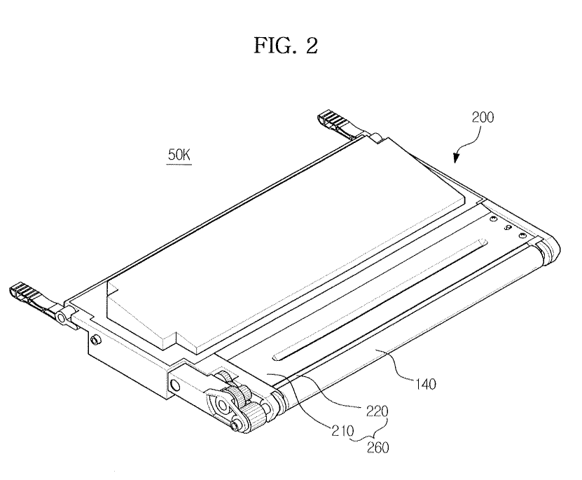

FIG. 2 is a perspective view illustrating the developer 50K as illustrated in FIG. 1. The following description will be given with reference to FIGS. 1 and 2. In the following description, the same configuration of the four developers 50Y, 50M, 50C, and 50K will be described only in conjunction with the developer 50K, which stores a developing agent of black color, to simplify the description.

As illustrated in FIGS. 1 and 2, the developer 50K includes a developer frame 200, a developing agent storing space 54, a supply roller 130, a developing device 140, a stirring member 150, and a regulating device 260.

The developer frame 200 defines an outer appearance of the developer 50K, and supports various elements provided at the developer 50K. In an interior of the developer frame 200, the developing agent storing space 54 is defined.

A developing agent, which will be supplied to the photosensitive body 40, is stored in the developing agent storing space 54. The stirring member 150 is rotatably arranged in the developing agent storing space 54. The stirring member 150 feeds the developing agent toward the supply roller 130 while stirring the developing agent stored in the developing agent storing space 54, to prevent the developing agent from congealing.

The supply roller 130 supplies the developing agent stored in the developing agent storing space 54 to the developing device 140. When a developing bias is applied to the developing device 140, the developing device 140 attaches the developing agent to the surface of the photosensitive body 40 formed with the electrostatic latent image, to form a visible image thereupon.

The regulating device 260 is mounted to the developer frame 200 at one side of the top surface of the developer frame 200. The regulating device 260 regulates a thickness of the developing agent attached to the surface of the developing device 140 by the supply roller 130, to form a uniform developing agent layer on the developing device 140.

The regulating device 260 includes a regulating member 220 to regulate the developing agent layer on the developing device 140, and a support member 210 to support the regulating member 220. The regulating member 220 has a first end fixed to the support member 210, and a second end elastically contacting the surface of the developing device 140.

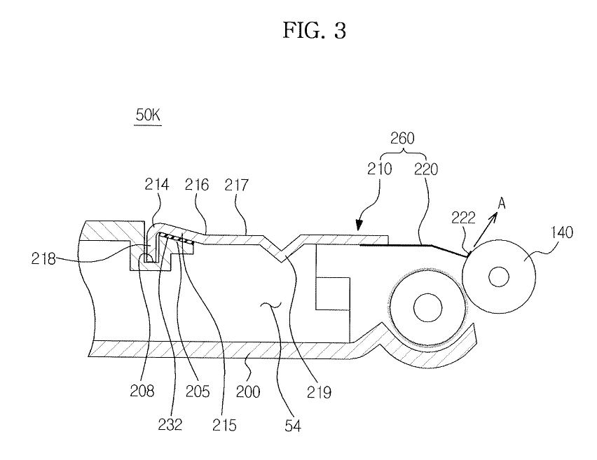

In the embodiment of FIGS. 2 and 3, the regulating member 220 is in contact with the developing device 140 in a trail-type manner. In the trail type, the regulating member 220 is installed such that the free end of the regulating member 220, which is in contact with the developing device 140, is directed in the same direction as the rotation direction of the developing device 140 (a direction A in FIG. 3). Where the trail type is used, it is possible to install the regulating device 260 without increasing the size of the developer 50K. In this case, accordingly, there is an advantage in terms of space utility. It is also possible to advantageously miniaturize the image forming apparatus 1.

Meanwhile, as illustrated in FIG. 1, the transfer unit 90 includes an intermediate transfer belt 91, a first transfer roller 92, and a second transfer roller 93.

The intermediate transfer belt 91 is supported by support rollers 94 and 95, to operate at a same velocity as a linear velocity of the photosensitive body 40. The first transfer roller 92 faces the photosensitive body 40 such that the intermediate transfer belt 91 is interposed between the first transfer roller 92 and the photosensitive body 40. In accordance with this arrangement, the visible image formed on the photosensitive body 40 is transferred to the intermediate transfer belt 91.

The second transfer roller 93 faces the support roller 95 such that the intermediate transfer belt 91 is interposed between the second transfer roller 93 and the support roller 95. The second transfer roller 93 is spaced apart from the intermediate transfer belt 92 during the image transfer from the photosensitive body 40 to the intermediate transfer belt 91. When the image transfer from the photosensitive body 40 to the intermediate transfer belt 91 is completed, the second transfer roller 93 comes into contact with the intermediate transfer belt 92 with a predetermined pressure. When the second transfer roller 93 comes into contact with the intermediate transfer belt 91, the image on the intermediate transfer belt 91 is transferred to a printing medium S.

The fusing unit 60 includes a heating roller 61 provided with a heating source (not illustrated), and a pressing roller 62 arranged to face the heating roller 61. When a printing medium S passes through a nip defined between the heating roller 61 and the pressing roller 62, the image transferred to the printing medium S is fused on the printing medium S by heat transferred from the heating roller 61 and a pressure exerted between the heating roller 61 and the pressing roller 62.

Meanwhile, the printing medium discharge unit 70 includes a discharge roller 71 and a discharge backup roller 72, to discharge the printing medium S emerging from the fusing unit 60 to the outside of the body 10.

Hereinafter, operation of the image forming apparatus 1 having the above-described configuration will be described in brief. When a printing operation starts, the surface of the photosensitive body 40 is uniformly charged by the charging roller 42. The uniformly-charged surface of the photosensitive body 40 is scanned by the light scanning unit 30 with light corresponding to image information of one color, for example, black. Accordingly, an electrostatic latent image corresponding to a black image is formed on the photosensitive body 40.

Thereafter, a developing bias is applied to the developing device 140 of the black developer 50K. As a result, a black developing agent is attached to the electrostatic latent image, so that a visible black image is formed on the photosensitive body 40. The visible image is then transferred to the intermediate transfer belt 91 by the first transfer roller 92.

After the completion of the black image transfer for one page, the light scanning unit 30 scans the photosensitive body 40 with light corresponding to image information of another color, for example, magenta. As a result, an electrostatic latent image corresponding to a magenta image is formed. The magenta developer 50M supplies a magenta developing agent to the electrostatic latent image, to form a visible image. The magenta visible image formed on the photosensitive body 40 is then transferred to the intermediate transfer belt 91 by the first transfer roller 92. At this time, the magenta visible image is overlapped with the black visible image already transferred to the intermediate transfer belt 91.

After the above-described procedure is carried out with regard to the cyan developer 50C and the yellow developer 50Y, a color image consisting of overlapped black, magenta, cyan, and yellow images is completely formed. The color image completely formed as described above is transferred to the printing medium S passing through the nip between the intermediate transfer belt 91 and the second transfer roller 93. The printing medium S is then outwardly discharged from the body 10 via the fusing unit 60 and printing medium discharge unit 70.

During the above-described printing procedure, the regulating device 260 regulates the developing agent attached to the developing device 140 such that the developing layer formed on the developing device 140 is uniform. However, since the regulating device 260 is installed in a trail-type manner, there may be a high possibility that the regulating member 220 moves together with the support member 210, thereby causing the developing agent layer on the developing device 140 to be non-uniform, when the support member 210 has an insufficient strength and an insufficient elasticity. Furthermore, the regulating device 260, which uses the trail type, is weak against the leakage of the developing agent because the regulating device 260 covers the developing agent storing space 54 over a wide area due to the structural form of the regulating device 260. To this end, the support member 210 of the regulating device 260 according to the present general inventive concept has an improved structure capable of obtaining a reinforced strength and a reinforced sealing effect.

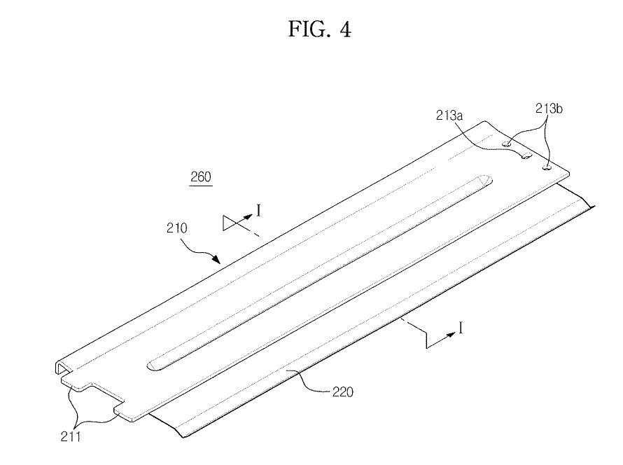

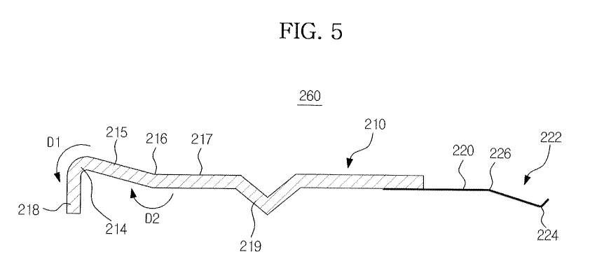

FIG. 3 is a sectional view illustrating the developer illustrated in FIG. 2. FIG. 4 is a perspective view illustrating the regulating device illustrated in FIG. 3. FIG. 5 is a cross-sectional view taken along the line I-I of FIG. 4, illustrating the regulating device.

As illustrated in FIGS. 3 through 5, the regulating device 260 includes the support member 210, which is mounted to the developer frame 200, and the regulating member 220, which is installed in a trail-type manner.

The support member 210 partially shields the top surface of the developer frame 200, and supports the regulating member 220. The support member 210 includes a first bending portion 214 and a second bending portion 216, which are bent in different directions, respectively.

The support member 210 is bent in a first direction D1 (see FIG. 5) at the first bending portion 214. Since the support member 210 is bent twice in inward and outward directions at the first and second bending portions 214 and 216, respectively, the support member 210 has an increased stiffness and an increased elasticity. One end of the support member 210 bent in the first direction D1 forms a frame coupling portion 218.

The frame coupling portion 218 is received in a coupling groove 208 provided at the developer frame 200. The frame coupling portion 218 is forcibly fitted in the coupling groove 208, to prevent the developing agent stored in the developing agent storing space 54 from leaking. This coupling structure provides easy assembly because it is unnecessary to use fastening members such as bolts. The frame coupling portion 218 is arranged at a first side of the first bending portion 214. An inclined portion 215 is arranged at a second side of the first bending portion 214.

The inclined portion 215 is formed as the support member 210 is bent from the first bending portion 214 in the first direction D1 by 90° or more. The inclined portion 215 has a structure inclined from a left upper position toward a right downward direction. The inclined portion 215 comes into close contact with an inclined frame 205, which has the same shape as the inclined portion 215. Since the inclined portion 215 and inclined frame 205 are in close contact with each other while having a structure inclined from the left upper position toward the right downward direction, it is possible to reduce a possibility that the developing agent stored in the developing agent storing space 54 is outwardly leaked between the inclined portion 215 and inclined frame 205. In addition, a first sealing member 232 is interposed between the inclined portion 215 and the inclined frame 205, which further reduces the possibility that the developing agent stored in the developing agent storing space 54 is outwardly leaked between the inclined portion 215 and inclined frame 205.

The second bending portion 216 is formed at a trailing end of the inclined portion 215 as the support member 210 is bent from the inclined portion 215 in a second direction D2. The second bending portion 216 bends the support member 210 in the second direction D2 opposite to the first direction D1, as compared to the first bending portion 214 which bends the support member 210 in the first direction D1. As the inclined portion 215 formed in accordance with the bending of the first bending portion 214 is subjected to the bending of the second bending portion 216, the inclined portion 215 forms a substantially-horizontal extension 217. The extension 217 extends horizontally to a position where the extension 217 is connected to the regulating member 220, with an exception regarding a region corresponding to an indent 219.

The indent 219 is provided at an intermediate portion of the extension 217. If the support member 210 extends horizontally to the regulating member 220 without having the indent 219, it exhibits a degraded strength and a degraded elasticity. Accordingly, the indent 219 is provided at an intermediate portion of the extension 217, to make the support member 210 have strength and a desired elasticity. Meanwhile, the support member 210 has curvatures provided not only by the indent 219, but also by the first and second bending portions 214 and 216. Accordingly, the support member 210 has an increased strength and an increased elasticity, as compared to a support member without curvatures. Since the support member 210 has an increased strength and an increased elasticity, as described above, the support member 210 and the regulating member 220 attached to the support member 210 exhibit a reduced movement tendency. Accordingly, the developing agent layer attached to the developing device 140 can be uniform. The extension 217 is joined to the trail-type regulating member 220 at a portion of the extension 217 which extends from the indent 219.

The regulating member 220 has a first end joined to the support member 220, and a second end, namely, a free end 222, which is in contact with the developing device 140. As illustrated in FIG. 3, the free end 222 of the regulating member 220 extends in a direction A which is identical to a linear velocity direction of the developing device 140 during the rotation of the developing device 140. The arrangement, in which the free end 222 of the regulating member 220 extends in the same direction as the linear velocity direction of the developing device 140, is an important feature of the trail-type developer 50K. The trail-type developer 50K is advantageous in terms of space utility because it is possible to install the regulating device 260 in parallel to the developer 50K. Accordingly, the image forming apparatus 1 having a small size can be realized.

As illustrated in FIG. 5, the free end 222 is provided at the other end of the regulating member 220, and has a bending portion 224 having a bending angle between 80° to 120°, preferably, about 90°. The bending portion 224 of the free end 222 substantially functions to regulate the developing agent layer on the developing device 140 while being in contact with the developing device 140. The bending portion 224 which extends from the free end 222 has a length between 1 mm to 3 mm, preferably, 1 mm to 2 mm.

A second bending portion 226 is formed between the free end 222 and one end of the regulating member 220 connected to the support member 210, in order to enable the bending portion 224 to regulate the developing agent layer on the developing device 140 with an appropriate elastic force.

The regulating member 220 is coupled at an upper surface thereof with a lower surface of the support member 210 in accordance with a coupling method such as a welding or bonding method, to form the regulating device 260. The coupling method may include a spot welding method using a laser or a bonding method using an adhesive such as a double-sided tape in order to maintain a desired coupling strength and a uniform elastic force. The possibility that the coupling fails is reduced by virtue of a force applied to the regulating member 220 during the rotation of the developing device 140, only when the bonding occurs between the upper surface of the regulating member 220 and the lower surface of the support member 210. If the bonding occurs between the lower surface of the regulating member 220 and the upper surface of the support member 210, the possibility that the coupling fails is increased due to a force applied to the regulating member 220 during the rotation of the developing device 140.

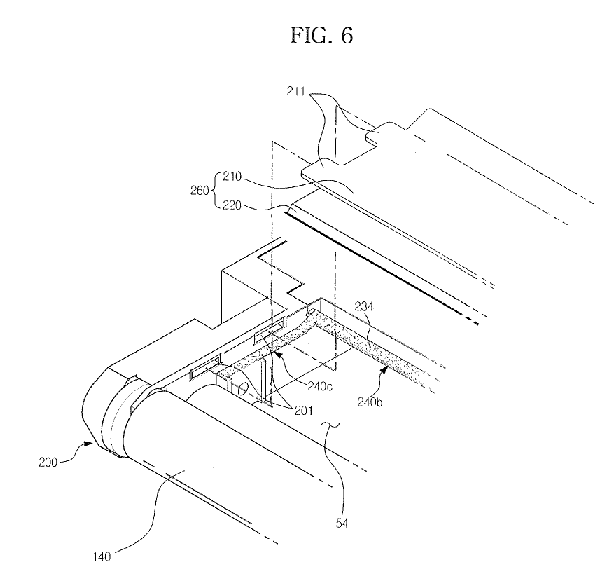

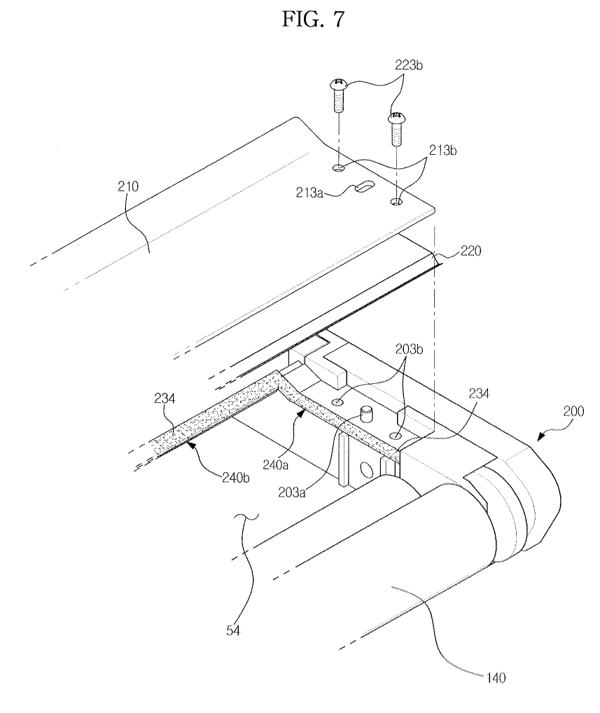

The assembly procedure of the developer having the above-described configuration according to an embodiment of the present general inventive concept will be described with reference to FIGS. 6 and 7.

FIGS. 6 and 7 are exploded perspective views of the developer illustrated in FIG. 2.

As illustrated in FIGS. 4, 6 and 7, engagement protrusions 211 are provided at one lateral end of the support member 210, to which the regulating member 220 is attached at an end of the support member 210.

The engagement protrusions 211 are slidably fitted in engagement grooves 201 provided at the developer frame 200 such that the engagement protrusions 211 are primarily engaged with the engagement grooves 201. The engagement protrusions 211 have a thickness substantially identical to the height of the engagement grooves 201. Accordingly, the engagement protrusions 211 are forcibly and slidably fitted in the engagement grooves 201. In accordance with the engagement between the engagement protrusions 211 and the engagement grooves 201, the engagement protrusions 211 are prevented from moving vertically and laterally. Since the movement of the engagement protrusions 211 is restricted, it is possible to reduce the possibility that the developing agent stored in the developing agent storing space 54 is leaked through a potential gap between the regulating member 220 and the support member 210. The developer frame 200 is also provided with supports 240a, 240b, and 240c to support the opposite lateral ends of the support member 210 and a longitudinal end of the support member 210 which is opposite to the regulating member 220.

The supports 240a, 240b, and 240c enable the support member 210 to be stably coupled to the developer frame 200. A second sealing member 234 is arranged on the supports 240a, 240b, and 240c. Since the second sealing member 234 is arranged on the supports 240a, 240b, and 240c, it is possible to reduce a possibility that the developing agent stored in the developing agent storing space 54 is leaked through a potential gap between the support member 210 and the developer frame 200.

A guide slot 213a and fastening holes 213b are provided at the support member 210 at a side opposite to the engagement protrusions 211. The guide slot 213a guides the fastening position of the support member 210. The fastening holes 213b are provided to fasten the support member 210 to the developer frame 200.

The guide slot 213a has an oval shape elongated in the longitudinal direction of the support member 210. A guide protrusion 203a which protrudes from the developer frame 200. When the engagement protrusions 211 of the support member 210 are fitted in the engagement grooves 201, the guide protrusion 203a is inserted into the guide slot 213a. Since the guide slot 213a has an oval shape elongated in the longitudinal direction of the support member 210, the guide protrusion 203a moves along the guide slot 213a during a sliding movement of the engagement protrusions 211 of the support member 210 along the engagement grooves 201. Thus, the guide protrusion 203a guides the support member 210 to the fastening position.

When the engagement protrusions 211 of the support member 210 are completely slidably fitted in the engagement grooves 201, the fastening holes 213b are vertically aligned with fastening grooves 203b which are provided at the developer frame 200. The aligned fastening holes 213b and fastening grooves 203b are fastened to each other by fastening bolts 223b.

As apparent from the above description, a regulating device 260 is firmly fastened to a developer frame in accordance with primary and secondary coupling structures so that the regulating device cannot move with respect to the developer frame. Accordingly, a developing agent stored in a developing agent storing space cannot be outwardly leaked.

Also, a support member of the regulating device has a reinforced stiffness and a reinforced elasticity by virtue of first and second bending portions and, and an indent. Accordingly, the developing agent layer attached to the developing device 140 can be uniform.

In accordance with embodiments of the present general inventive concept, it is possible to uniformly regulate the developing agent layer on the developing device by the trail-type regulating device improved to maintain a sufficient strength and a sufficient elasticity.

In accordance with embodiments of the present general inventive concept, the regulating device and developer frame can be firmly fastened to each other, so that they do not move with respect to each other. Accordingly, the developing agent stored in the developing agent storing space is prevented from being outwardly leaked.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developer, comprising:
a developer frame to store a developing agent;
a developing device rotatably mounted to the developer frame;
a support member mounted to the developer frame; and
a regulating member having a first end fixed to the support member, and a second end opposite to the first end which is provided in a trail-type position,
wherein the support member comprises a plurality of bending portions bent to reinforce a strength of the support member.

2. The developer according to claim 1, wherein the plurality of bending portions comprises:
a plurality of bending portions bent in different directions.

3. The developer according to claim 2, wherein the plurality of bending portions comprise:
a first bending portion bent in a first direction to cause a portion of the support member to be directed to an inside of the developer frame.

4. The developer according to claim 2, wherein the plurality of bending portions comprise:
a second bending portion bent in a second direction to cause a portion of the support member to be directed to an outside of the developer frame.

5. The developer according to claim 3, wherein the support member further comprises:
a frame coupling portion to extend from the first bending portion and to couple to the developer frame.

6. The developer according to claim 5, wherein the developer frame comprises:
a coupling groove to receive the frame coupling portion.

7. The developer according to claim 3, wherein:
the plurality of bending portions further comprise:
a second bending portion bent in a second direction to cause a portion of the support member to be directed to an outside of the developer frame; and
the support member further comprises:
an inclined portion to extend inclinedly from the first bending portion to the second bending portion, and
an extension to extend from the second bending portion toward the regulating member.

8. The developer according to claim 7, wherein the developer frame further comprises:
an inclined frame portion to correspond to the inclined portion of the support member.

9. The developer according to claim 7, wherein the extension is in contact with a developing agent storing space defined in the developer frame.

10. The developer according to claim 7, wherein the extension is formed with an indent to obtain a reinforcement in strength.

11. The developer according to claim 3, further comprising:
a sealing member interposed between the support member and the developer frame near the first bending portion.

12. The developer according to claim 1, wherein:
the support member further comprises:
at least one engagement protrusion laterally protruded from one side of the support member; and
the developer frame comprises:
at least one engagement groove engagable with the engagement protrusion.

13. The developer according to claim 1, wherein the support member further comprises:
a fastening hole to fasten the support member to the developer frame, and
a guide slot to guide the support member to a fastening position.

14. An image forming apparatus, comprising:
an image carrier; and
a developer comprising:
a developer frame defined with a developer storing space in an interior of the developer frame,
a developing device to feed a developing agent to the image carrier,
a regulating member to regulate a thickness of a developing agent layer attached to the developing device, and
a support member to support the regulating member, including a frame coupling portion fitted in the developer frame, an inclined portion bent from the frame coupling portion in a first direction, and extended along the developer frame, and an extension bent from the inclined portion in a second direction, and extended toward the regulating member, to cover a top of the developing agent storing space.

15. The image forming apparatus according to claim 14, wherein the developer further comprises:
a sealing member interposed between the developer frame and the inclined portion.

16. The image forming apparatus according to claim 14, wherein the support member is primarily coupled to a side surface of the developer frame through groove and protrusion structures.

17. The image forming apparatus according to claim 16, wherein the support member, which has been primarily coupled to the developer frame, is fastened to the developer frame.

18. An image forming apparatus, comprising:
a developer frame to store a developing agent;
a developing device rotatably mounted to the developer frame;
a support member mounted to the developer frame, the support member comprising at least one bending portion to reinforce a strength of the support member; and
a regulating member having a first end fixed to the support member, and a second end opposite to the first end and contacting the developing device while being directed in a same direction as the rotation direction of the developing device,
wherein the regulating member comprises at least one bending portion to reinforce an elasticity of the regulating member.

19. The image forming apparatus according to claim 18, wherein the support member comprises a plurality of bending portions bent in different directions.

20. The image forming apparatus according to claim 19, wherein the plurality of bending portions comprises:
a first bending portion bent in a first direction, to cause a portion of the support member to be directed to an inside of the developer frame.

21. The image forming apparatus according to claim 19, wherein the plurality of bending portions comprise:
a second bending portion bent in a second direction to cause a portion of the support member to be directed to an outside of the developer frame.

22. The image forming apparatus according to claim 20, wherein:
the support member further comprises:
a frame coupling portion extending from the first bending portion, the frame coupling portion being coupled to the developer frame; and
the developer frame comprises:
a coupling groove to receive the frame coupling portion.

23. The image forming apparatus according to claim 20, wherein:
the plurality of bending portions further comprise:
a second bending portion bent in a second direction to cause a portion of the support member to be directed to an outside of the developer frame; and
the support member further comprises:
an inclined portion to extend inclinedly from the first bending portion to the second bending portion, and
an extension to extend from the second bending portion toward the regulating member.

24. The image forming apparatus according to claim 23, wherein the developer frame further comprises:
an inclined frame portion corresponding to the inclined portion of the support member.

25. The image forming apparatus according to claim 23, wherein the extension is in contact with a developing agent storing space defined in the developer frame.

26. The image forming apparatus according to claim 23, wherein the extension is formed with an indent to obtain a reinforcement in strength.

27. The image forming apparatus according to claim 18, wherein:
the support member further comprises:
at least one engagement protrusion laterally protruded from one side of the support member; and
the developer frame comprises:
at least one engagement groove engagable with the engagement protrusion.

28. The image forming apparatus according to claim 18, wherein the at least one bending portion of the regulating member comprises:
a first bending portion to contact the developing device.

29. The image forming apparatus according to claim 28, wherein the at least one bending portion of the regulating member further comprises:
a second bending portion provided between the first bending portion of the regulating member and the support member.

30. A regulating device usable in a developer including a developer frame defined with a developer storing space in an interior of the developer frame, a developing device to feed a developing agent to form images, a regulating member to regulate a thickness of a developing agent layer attached to the developing device, and a support member to support the regulating member, the regulating device comprising:
a support member mounted to the developer frame, the support member comprising at least one bending portion to reinforce a strength of the support member; and
a regulating member having a first end fixed to the support member, and a second end arranged opposite to the first end, and installed in a trail-type manner, the regulating member comprising at least one bending portion to reinforce an elasticity of the regulating member.

31. A developer, comprising:
a developer frame to store a developing agent and including a developing device rotatably mounted to the developer frame; and
a regulating device to cover an opening of the developer frame to prevent the developing agent from leaking therefrom, and to regulate an amount of developer on a surface of the developing device, the regulating device including a plurality of bending portions bent to reinforce a strength thereof.

32. The developer of claim 31, wherein the regulating device further comprises:
a support member comprising a frame coupling portion to couple the support member to the developer frame; and
a regulating member coupled to the support member and to contact the surface of the developing device in a trailing type manner.

33. The developer of claim 32, wherein:
the developer frame comprises a coupling groove; and
the support member further comprises a first bending portion expending to the frame coupling portion to allow the frame coupling portion to slidably insert into the coupling groove.

34. The developer of claim 33, wherein the support member further comprises:
an inclined portion to couple to a corresponding inclined portion of the developer frame;
a second bending portion coupled to the inclined portion such that the second bending portion is bent in a direction opposite to a direction which the first bending portion is bent; and
a substantially horizontal extension to couple the second bending portion to the regulating member.

35. The developer of claim 34, wherein the support member further comprises:
an indent portion formed along the substantially horizontal extension to protrude toward an inside portion of the developer frame.

36. The developer of claim 32, wherein the regulating member is coupled to a surface of the support member facing an inside portion of the developer frame.

37. The developer of claim 32, wherein the regulating member comprises:
a first bending portion to allow a surface of the regulating member facing an inside portion of the developer frame to contact the developing device; and
a second bending portion to bend the regulating member to form a free end which is perpendicular to a rotating direction of the developing device.

38. The developer of claim 32, wherein:
the developer frame further comprises a plurality of engagement grooves; and
the support member further comprises a plurality of engagement protrusions located on side portions thereof to slidably fit into the engagement grooves of the developer frame to couple the support member thereto.
